(19) United States
(12) Patent Application Publication
(10) Pub. No.: US 2009/0237325 A1
(43) Pub. Date: Sep. 24, 2009

(54) System for Clustering Displays of Display Devices

(75) Inventors: XUN LUO, San Diego, CA (US); KRISHNA JONNALAGADDA, ALGONQUIN, IL (US); FRANCESCA SCHULER, DESPLAINES, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/961,366

(22) Filed: Dec. 20, 2007

(51) Int. Cl. G09G 5/00

(52) U.S. Cl. 345/2.1

(57) ABSTRACT

A method and system for clustering displays is disclosed. The system includes a master display device and one or more slave display devices. The master display device includes a virtual frame buffer configured to store pixel data of content to be displayed on a display cluster. The display cluster id formed by physically aligning the display devices. The master display device includes a layout coordinator is configured to manage a set of pointers to sub-regions of the display cluster. Each sub-region is formed by a display of a display device. The master display further includes a User Interface (UI) coordinator configured to integrate UI events occurring at each display device and a network dispatcher configured to monitor networking conditions. The network dispatcher also allocates bandwidth for transmission of pixel streams to slave display devices. Each of the slave display devices includes a display proxy configured to receive pixel streams from master display device. The pixel streams correspond to a portion of the content to be displayed on the sub-region formed by the slave display device. The slave display device further includes a User Interface (UI) proxy configured to communicate the UI event occurring at the slave display device to the master display device.

### FIELD OF THE DISCLOSURE

The present disclosure relates generally to display devices and more particularly to clustering displays of display devices.

### BACKGROUND

Portable electronic devices including cellular telephone handsets, personal digital assistants (PDAs), and handheld gaming devices among other devices, have become increasingly popular, particularly in mobile societies. Unfortunately, native displays of such devices are not infinitely scalable with respect to practical human usage. At some point, a given display can be too small to be of any practical use. This point can be a function of the limits of human perception, the quantity of information to be displayed at any given time on the display, or both. Such limits represent a significant challenge as products such as cellular telephones, personal digital assistants, small personal computers and the like both shrink in size while gaining increased functionality and/or networking capability.

Others have endeavored to address competing demands for large display areas. Examples of such endeavors are an expandable display having multiple folding sections in a handheld computing device, wherein the display is expandable upon unfolding the multiple display sections. An alternative embodiment includes a retractable e-paper display screen that is supported by a folding panel that may be expanded.

However, with the slow realization of borderless and/or flexible displays in electronic devices, clustering of traditional displays from multiple devices provides an alternative means for obtaining larger, effective displays and can also be applied to borderless and flexible displays in the future.

Accordingly, there is a need for a method and system for Clustering Displays.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating an environment where various embodiments of the present invention may be practiced.

FIG. 2 is a block diagram illustrating a system for clustering displays.

FIG. 3 is a flowchart of a method for clustering displays in accordance with an embodiment of the present invention.

FIG. 4 is an illustration of a method of creating a list of display configurations in accordance with an embodiment of the present invention.

FIG. 5 is a block diagram illustrating displays clustered in accordance with an embodiment of the present invention.

FIG. 6 is a flowchart of a method for clustering displays in accordance with another embodiment of the present invention.

FIG. 7 is a flowchart of a method for clustering displays in accordance with another embodiment of the present invention.

FIG. 8 is a flowchart of a method for clustering displays in accordance with another embodiment of the present invention.

FIG. 9 is a sequence diagram illustrating a display device joining a display cluster.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention provide a method and a system for clustering displays. The method includes collecting clustering information of display devices. A profile is generated from the collected clustering information. A list of display configurations for the display devices is created based on the generated profile. A particular display configuration is selected from the created list of display configurations for clustering the displays and content is displayed on a display cluster. The display cluster is formed by clustering the displays of display devices in accordance with the selected display configuration.

Before describing in detail the method and system for clustering displays, it should be observed that the present invention resides primarily in combinations of method steps and system components related to a method and system for clustering displays. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

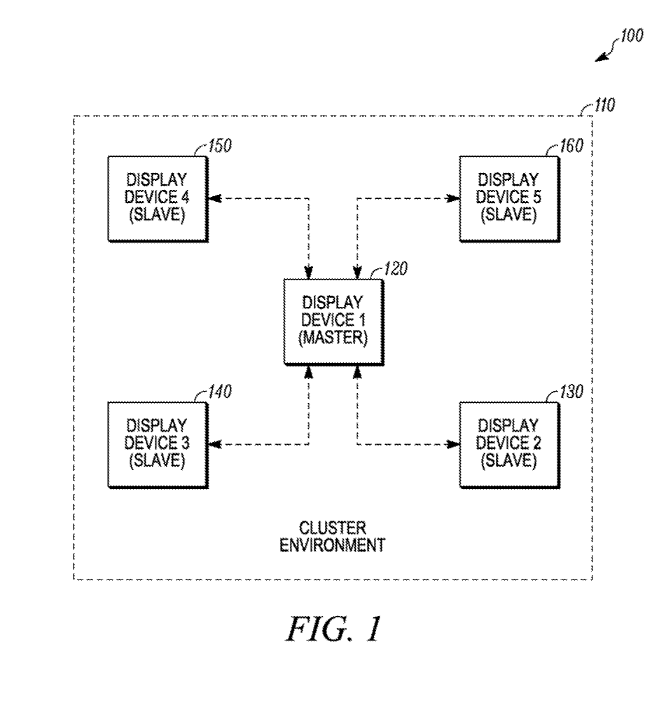

FIG. 1 is a block diagram illustrating an environment 100 where various embodiments of the present invention may be practiced. The environment includes a cluster environment 110, a first display device 120, a second display device 130, a third display device 140, a fourth display device 150, and a fifth display device 160. Each of the display devices 120-150 may be any type of mobile electronic device having a display and wireless communication capability. Examples of display devices include, but are not limited to, cellular telephone handsets, personal digital assistants (PDAs), and handheld gaming devices. In an example embodiment, the first display device 120 is a master display device and the display devices (130-160) are slave display devices. The master display 120 device may be the display device having control to cluster display devices (120-160) and share content on a clustered display of the display devices (120-160). Examples of content are video, image, user interface, and so forth. The cluster environment 110 is a range within which short-range communications can be supported. In an example, the cluster environment 110 is within a range of 150 ft. Short-range communications are for e.g., Bluetooth® (“BLUETOOTH® is a registered trademark of Bluetooth SIG”), WiFi® (“WI-FI® is a registered trademark of the Wi-fi alliance”), UWB, Zigbee® (“Zigbee® is a registered trademark of Zigbee alliance), whispering optical display etc. The display devices (120-160) communicate with each other and connect with each other through short-range communications when the display devices (120-160) are within the cluster environment 110.

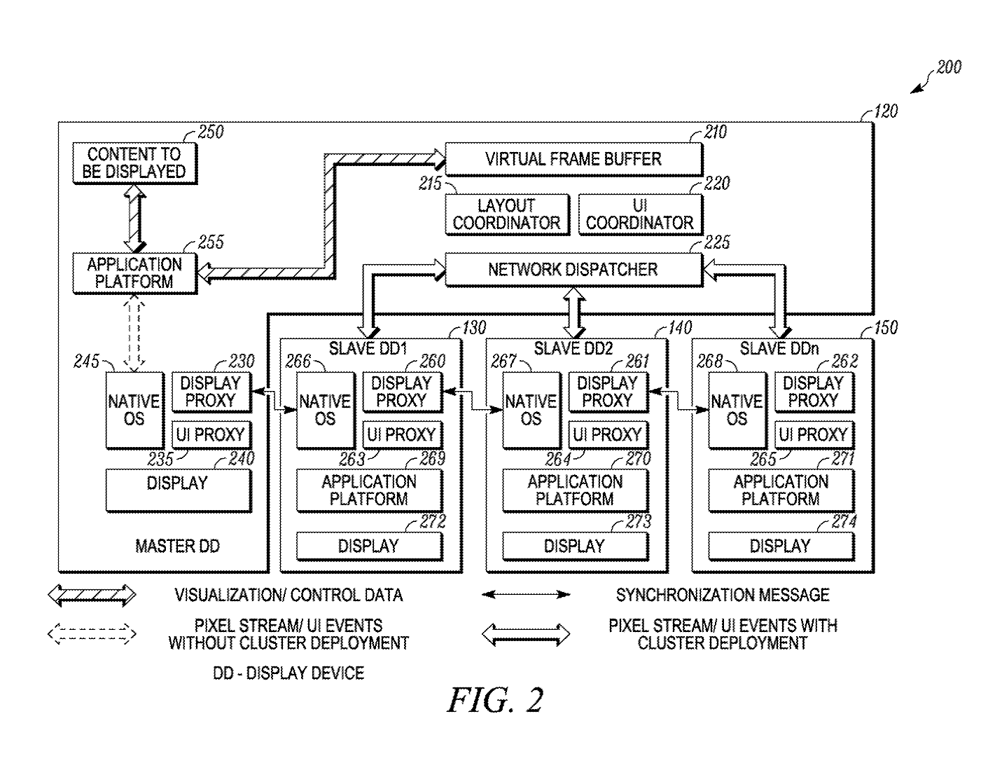

FIG. 2 is a block diagram illustrating a system 200 for clustering displays devices (120-150) in the cluster environment 110. The system 200 includes a master display device, such as the first display device 120 and one or more slave display devices, such as second, third, and fourth display devices (130-150). As such, each display device within the system 200 is capable of participating in clustering and display sharing. The master display device 120 includes a virtual frame buffer 210, a layout coordinator 215, a user interface (UI) coordinator 220, and a network dispatcher 225. The virtual frame buffer 210 is configured to store pixel data of the content to be displayed on the display cluster. The layout coordinator 215 is configured to manage a set of pointers to sub-regions of the display cluster. The set of pointers to a sub-region determine which pixels of the content corresponds to a sub-region. A sub-region is formed by a display of a display device. The UI coordinator 220 is configured to integrate UI events occurring at each display device (120-150). A UI event is a user interaction at one of the display devices (120-150). Examples of user interaction are a key press, touch, tap, or voice tag on the display device. A UI event occurring at a display device may signify control transfer and re-orientation of displayed content. The network dispatcher 225 is configured to monitor networking conditions and for allocating bandwidth for transmission of pixel streams to slave display devices (130-150).

The slave display devices (130-150) include a display proxy (260-262) and a user interface (UI) proxy (263-265). The display proxies (260, 261, and 262) are configured to receive pixel streams from the master display device 120. The pixel streams correspond to a portion of the content that is to be displayed 250 on the sub-region formed by the slave display device (130, 140, or 150). The display proxy (260, 261, or 262) then passes the received pixel streams to a rendering layer. The UI proxies (263, 264, and 265) are configured to communicate the UI event occurring at the slave display device (130, 140, or 150) to the master display device 120. Transfer of control between master display device and slave display devices is made using synchronization messages. Synchronization messages provide out-of-the-band channel for meta control data transfer. Such synchronization messages aid frame synchronization as well. Pixel streaming links are used for streaming pixels.

The master display device 120 also includes a display proxy (230) and a UI proxy (235) which functions as discussed above. The master display device further includes an operating system 245, an application platform 255 and a display 240. Examples of application platform include Java® (“JAVA® is a registered trademark of Sun Microsystems, Inc.”), BREW® (“BREW® is a registered trademark of QUALCOMM, Inc.”) etc. The slave display devices (130-150) further include a virtual frame buffer (not shown), a layout coordinator (not shown), a UI coordinator (not shown), and a network dispatcher (not shown) all which functions as discussed above. Each of the slave display devices (130-150) further includes an operating system (266, 267 or 268), an application platform (269,270 or 271), and display (272, 273, or 274). When the master display device 120 transfers control to a slave display device (130, 140, or 150), the slave display device (130, 140, or 150) acts as a master display device and the master display device 120 acts as a slave display device. The master display device 120 and the slave display device (130, 140, and 150) are synchronized with one another through short range communication methods. Examples of short range communication methods are Bluetooth®, WiFi®, UWB®, Zigbee®, or Whispering optical display.

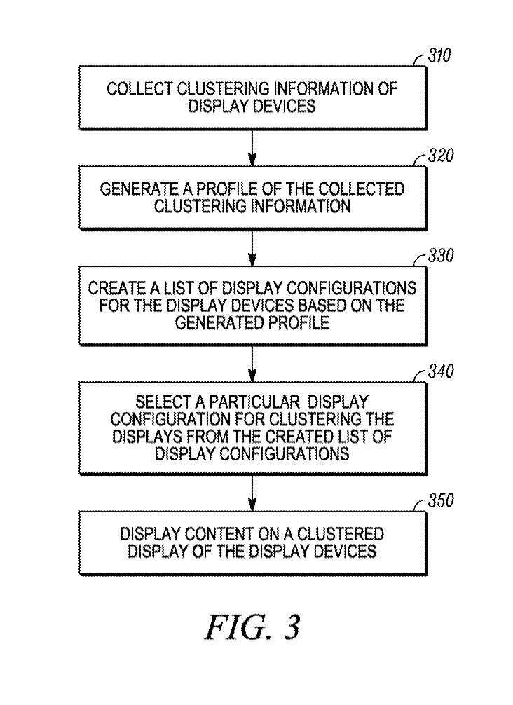

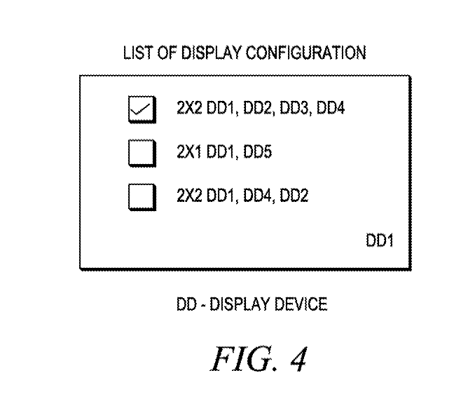

FIG. 3 is a flowchart of a method for clustering displays of display devices (120-160) in a cluster environment 100 in accordance with an embodiment of the present invention. At step 310, the master display device 120 collects clustering information from each of the slave display devices (130-160). The clustering information is for e.g., screen geometries, display characteristics, wireless communication protocols that are available at the display device and device capabilities of the display device. At step 320, the master display device 120 generates a profile of the collected clustering information. Generating a profile means generating a summary of the resources available in a display device (120-160). The summary also includes capabilities of the display device (120-160). At step 330, the master display device 120 creates a list of display configurations (as shown in FIG. 4) for the display devices (120-160) after analyzing the profile. A display configuration is the way in which the display devices are arranged to form a composite display surface. In an example embodiment, at least two display devices have displays shaped differently from each other. The composite display surface over which content is displayed will hereinafter be referred as a display cluster.

In an embodiment, the master display device 120 creates a prioritized list of display configurations. The display configurations are prioritized based on an analysis of the clustering information of each of the display devices (120-160). In an example, Greedy Heuristic (GH) algorithm is used for prioritizing the display configurations based on analyzing one of several parameters like screen size, border dimensions etc., of each display device. The GH algorithm assumes unified resolution across the display devices. In an example, the GH algorithm calculates a screen size fitness value as follows,

Screen Size Fitness=1−(size_gap_or_extruding_area)/ΣSize(DDi),

### Where,

size_gap_or_extruding_area—difference between the dimensions of at least two display devices,

Size (DD) is the size of the display of display device (DD), where i=1 to n.

Accordingly, the GH algorithm starts calculating the screen size fitness value starting from the display device that has the largest screen size and iteratively tries out alignment with other display devices that minimize screen size fitness value in each iteration.

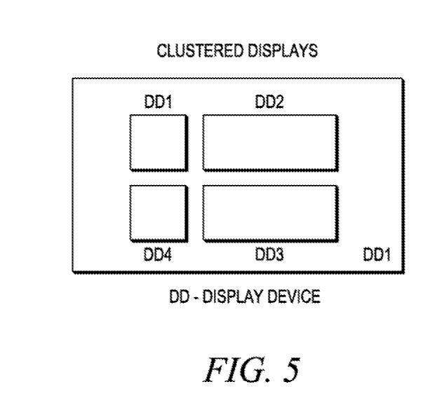

At step 340, a particular display configuration is selected from the created list of display configurations for clustering the displays. In an embodiment, the master display device 120 selects a display configuration based on preferences set by a user. The preferences are preset by the user and the master display device 120 automatically selects a display configuration that matches the user's preferences. In another embodiment, the list of display configurations is available to the user such that the user manually selects a display configuration from the list. Once the display configuration is selected, the displays of the display devices (120-160) are clustered in accordance with the selected display configuration to form the display cluster as shown in FIG. 5. In an embodiment, clustering the displays means physically aligning each of the plurality of display devices (120-160) on a single plane to form the composite display surface. In another embodiment, clustering the displays means physically aligning each of the plurality of display devices (120-160) on more than one plane to form the composite display surface. The physically aligned display devices (120-160) are then wireless connected to each other using e.g., Bluetooth®, Wifi®, and Whispering optical display. Since the display devices (120-160) are wirelessly connected, the displays of the display devices (120-160) retain their respective image components even if they are physically placed apart from each other.

In an embodiment, instead of the master display device 120 creating a list of display configurations, the user simply lays the display devices in a configuration of the user's choice with the sides of the display devices touching each other, and the master display device 120 lays the content on the user selected configuration of display cluster.

At step 350, the master display device 120 displays content on the display cluster. In an embodiment, the master display device 120 verifies whether the displays are clustered in accordance with the selected display configuration. If the displays are not clustered in accordance with the selected display configuration, the user is notified of an error until the displays are clustered to match the selected display configuration. In an example, the display cluster is validated using proximity sensors based on optical or RF deployed along the edges of the display devices. The sensors detect a mutual alignment of the display devices and provide information regarding a relative alignment of the display devices. This information is then used for validating the display cluster.

Each display device, master or slave, may be capable of automatic sensing and awareness of the position of the other display devices relative to each other. The relative location can be detected using proximity sensors based on, for example, an optical signal detected by photodiodes or optical fibers on at least one side, and up to all sides, of the display device. For one embodiment, display device A may know that display device B is located at its first side, there is no device at its second side, display device C is located at its third side, and display device D is located at its fourth side. All other display device in the cluster have the same awareness. Thus, even though the connections are wireless, the display devices may know their respective positions, enabling complex composite display functionality.

If a display device operated by a user aligns the other display devices in a format or configuration different from the suggested format or configuration, the system may optimize the content to the available configuration. For example, a display device may decide not to use a particular screen based on the type of content. This also facilitates automatic compensation for a display device joining or leaving the cluster. The proximity sensors may be based on other near line-of-sight technologies such as NFC, IR and whispering displays. Orientation and position can also be obtained by motion sensing with integrated accelerometers, gyroscopes and electronic compass.

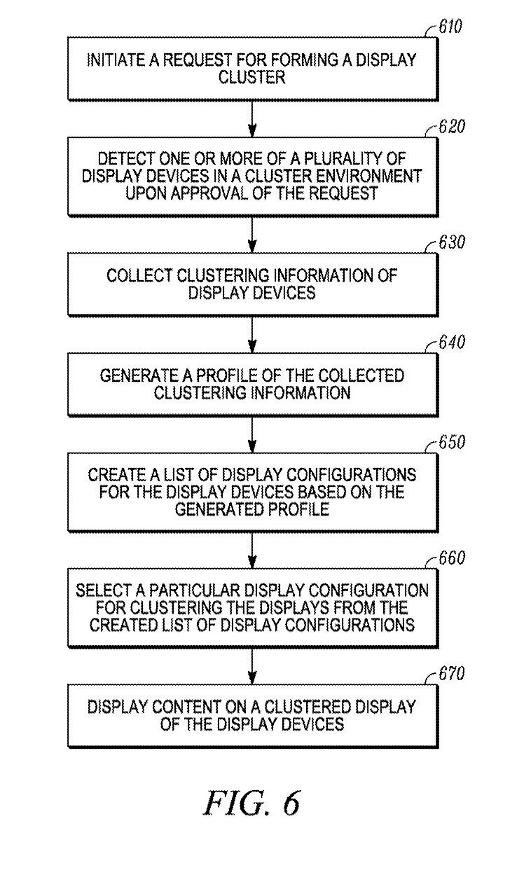

In an embodiment, as shown in FIG. 6, at step 610, the master display device 120 initiates a request for forming a display cluster. The request is initiated by the master display device 120 based on context. In this embodiment, context data may be a location, calendar, or display cluster activation instance which is stored in the master display device 120. The master display device 120 periodically compares a current context data to the stored context data and proactively suggests clustering formation. Alternatively, the master display device 120 initiates a request for forming a display cluster based on prior history, application type, visualization content type etc. Prior history here means history of how the current content was displayed. At step 620, once the user approves the request for forming a display cluster, the master display device 120 looks for one or more display devices (130-160) in the cluster environment 110. On detecting one or more display devices (130-160), the master display device 120 requests the display devices (130-160) for clustering information. The master display device 120 then performs steps 630-670 similar to steps 310 through 350 of FIG. 3.

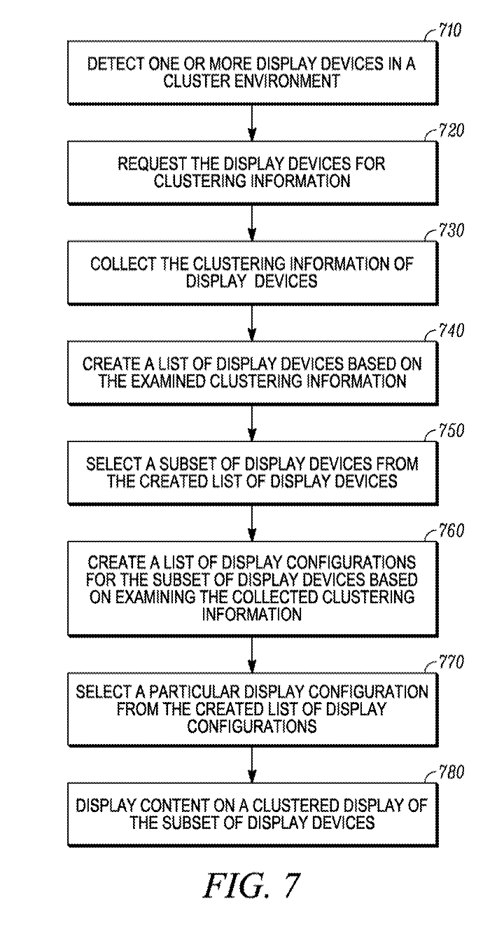

In another embodiment as shown in FIG. 7, at step 710, the master display device 120 detects one or more display devices (130-160) in the cluster environment 110. At step 720, the master display device 120 requests the slave display devices (130-160) for clustering information. At step, 730, the master display device 120 collects clustering information from the slave display devices (130-160). At step 740, upon collecting clustering information from slave display devices (130-160), the master display device 120 creates a list of display devices based on the collected clustering information. The display devices are listed based on determining whether the display devices are conducive to clustering. This determination is based on device capabilities and display characteristics that support clustering of displays. In an embodiment, master display device 120 creates a prioritized list of display devices based on device capabilities and display characteristics. At step 750, the master display device 120 selects a subset of display devices from the created list of display devices. In an example, the master display device 120 selects the subset of display devices based on a user preference. The user preference may be based on display device model or display characteristics. In another example, the created display device list is available to the user, such that the user selects a subset of display devices based on the user's choice. Upon selecting the subset of display devices from the created list of display devices steps 760-780 are performed for the subset of display devices similar to steps 330 through 350 of FIG. 3.

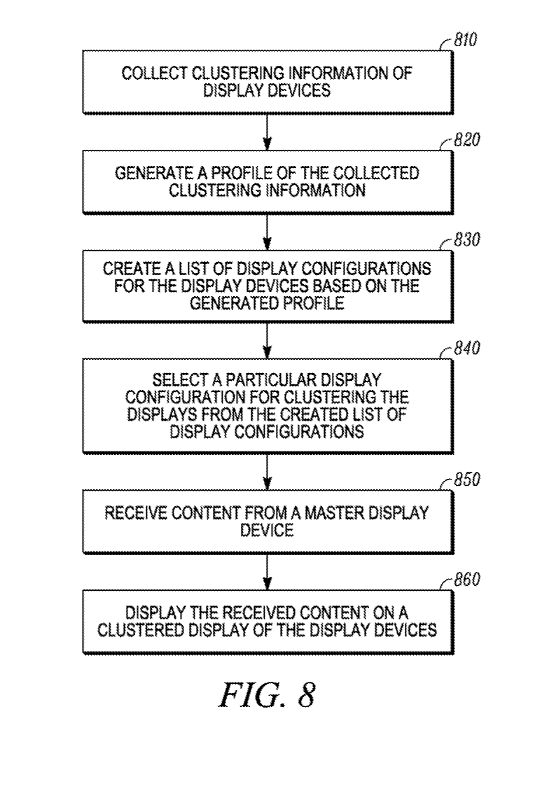

In yet another embodiment as shown in FIG. 8, the master display device (not shown) is external to the display cluster but is wirelessly connected to the slave devices and can control display configurations, etc. as described. In such an embodiment, the display cluster is formed by the slave display devices (130-160) in steps 810-840 similar to steps 310-340 of FIG. 3. At step 850, the slave display devices (130-160) receive content from the external master display device and at step 860 the received content is displayed on the display cluster. In such an embodiment, the external master display device acts as a services provider and the slave display devices (130-160) serve to provide an expanded display surface. In an example, the external master display device has device resources like GPS, Mobile TV, high resolution camera, gaming, or subscription services but has poor or no display, small screen, and/or no clustering capabilities. In an example, the slave display devices have large screen, high display resolution, borderless/flexible display, and/or clustering properties. The external master display device captures a high resolution picture using its high resolution camera and transfers content to the slave display devices. The content is displayed on the display cluster of the slave display devices. In another embodiment, the master display device is capable of running multiple services. In an example, the master display device sends content such as stored or streamed video, images, GPS maps, etc. to the cluster formed by the slave display devices while the master display device is being used for another function such as making phone calls.

An out-of-cluster display device, such as master display device that is outside a cluster, may also alter or control the orientation of the displayed content on display devices that are in-cluster. For example, rotating the master display device that is outside the cluster may also rotate the displayed content of the in-cluster slave devices. In addition to rotation, the master display device may actuate alteration or control in other ways, such as through key press, touch, tilt, or tap at one of the display devices.

In an embodiment, the control from the master display device 120 is transferred to a slave display device (130, 140, 150, or 160) i.e. any of the slave display devices (130, 140, 150, or 160) can behave as a master display device. Transferring control from the master display device 120 to the slave display device (130, 140, 150, or 160) may be performed through activation of a user interface at the slave display device (130, 140, 150, or 160). Examples of activating a user interface are through a single interaction like touch, key press, tap, voice tag, and so forth. Upon activation of a user interface, appropriate control messages are sent through synchronization message channel to be broadcasted within the cluster. Once the control is transferred to the slave display device (130, 140, 150, or 160), the slave display device (130, 140, 150, or 160) behaves as a master display device and shares content to be displayed on the display cluster.

In an embodiment, the orientation of the displayed content can be altered by a single interaction on any display device (120-160) participating in the display cluster. Examples of single interaction are key press, touch, tilt, rotation, or tap. Tilt, rotation, tap etc. may be measured using integrated sensors such as accelerometers and gyroscopes. The orientation of the displayed content is altered such that the content can be optimally viewed from the perspective of the vertex of the device on which the single interaction is performed. In an example, a tap on the second display device would alter the orientation in such a way that the user at the second display device can optimally view the displayed content.

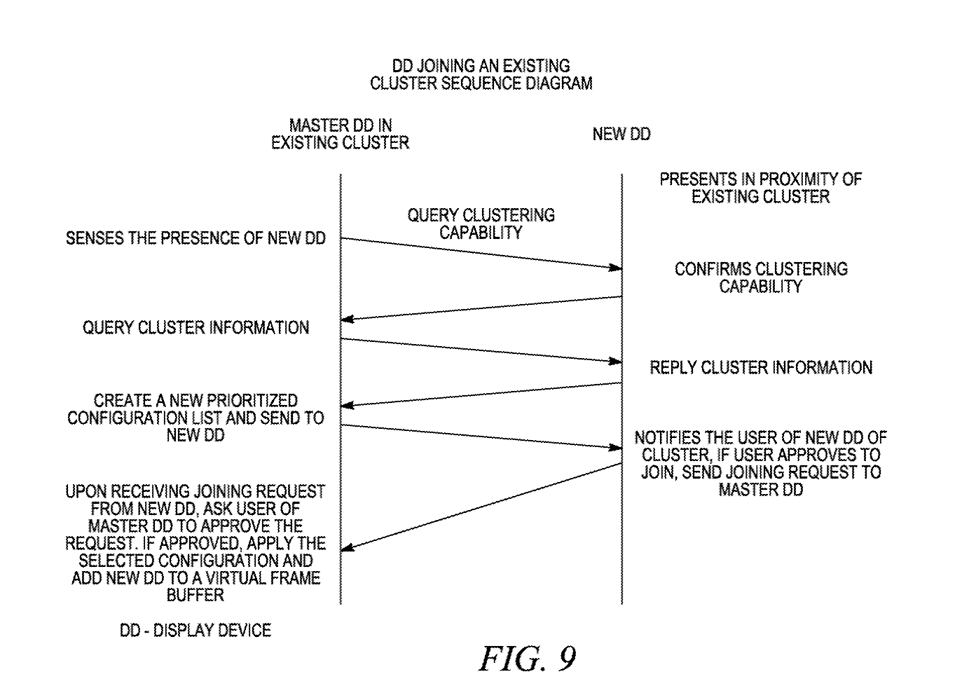

FIG. 9 is a sequence diagram illustrating a display device joining a display cluster. The master display device 120 monitors the cluster environment for a new display device. The master display device monitors for the new display device (not shown) using e.g., Bluetooth®, WiFi®, UWB®, Zigbee®, and IR. The new display device is any display device in the proximity of the existing display cluster within the cluster environment 110. When the master display device 120 detects the new display device in the cluster environment 110, the master display device 120 queries the new display device for clustering capabilities. Examples of clustering capabilities are display characteristics, connectivity, and device capabilities. Once the new display device confirms its ability to cluster, the master display device 120 requests for clustering information from the new display device. The new display device then replies with its clustering information. The master display device 120 then updates the profile with the clustering information of the new display device. Using the updated profile, the master display device 120 creates a new list of display configurations for the display devices. The master display device 120 notifies the new display device of the existing cluster. The new display device sends a request for joining the cluster to the new display device. Once the new display device's request is approved, the new display device joins the cluster. The position of the new display device in the display cluster is in accordance with the display configuration selected from the new list of display configurations. The content is then displayed on the new display cluster.

Similarly, the master display device 120 detects an absence of a display device (130-150, or 160) from the display cluster i.e. the master display device 120 detects when a display device leaves an existing display cluster. The master display device 120 detects the absence of a display device (130-150, or 160) through e.g., Bluetooth®, proximity sensors, motion gesture sensors and so forth. Upon detecting that a display device (130-150, or 160) has left the display cluster, the master display device 120 creates a new list of display configurations based on the display devices remaining in the display cluster. A particular display configuration is selected from the new list of display configurations. The displays of the remaining display devices are clustered in accordance with the selected display configuration and the content is displayed on the new display cluster.

In an embodiment, the display cluster supports composite input as well as composite output. For example, the user selects a widget/icon on a first display device in the display cluster and drags his/her finger across the first display device's display, across the edge of the first display device and across the edge of a second display device, and onto the display of the second display device to copy for e.g., a song or a photo represented by that widget/icon. In an example, in a game of chess, the composite input may be used to move a game token on a board represented by the display cluster. A UI event occurring at each display device (120-150) is mapped from a local coordinate system specific to a display device (120-150) to a global coordinate system specific to a virtual frame buffer manager of the master display device 120. The UI event occurring at a display device (120-150) is communicated to the master display device by the UI proxy (263, 264, or 265) of respective display devices (120-150).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for clustering displays of display devices including a master display device and one or more slave display devices, comprising:
the master display device comprising:
a virtual frame buffer configured to store pixel data of content to be displayed on a display cluster;
a layout coordinator configured to manage a set of pointers to sub-regions of the display cluster, wherein each sub-region is formed by a display of a display device;
a User Interface (UI) coordinator configured to integrate UI events occurring at each display device; and
a network dispatcher configured to monitor networking conditions and for allocating bandwidth for transmission of pixel streams to slave display devices; and each slave display device comprising:
a display proxy configured to receive pixel streams from the master display device, wherein the pixel streams correspond to a portion of the content to be displayed on the sub-region formed by the slave display device; and
a User Interface (UI) proxy configured to communicate the UI event occurring at the slave display device to the master display device.

2. The system as claimed in claim 1, wherein the display cluster is formed by physically aligning the display devices.

3. The system as claimed in claim 1, wherein the set of pointers to sub-regions determine which pixels of the content corresponds to a sub-region.

4. The system as claimed in claim 1, further comprising a means for detecting, by the master display device, an orientation and location of at least one slave display device.

5. The system as claimed in claim 1, wherein the UI event includes control transfer and re-orientation of displayed content.

6. The system as claimed in claim 1, wherein the master display device and the slave display device are synchronized with each other through short range communication methods including Bluetooth®, Wifi®, or Whispering optical display.

7. The system as claimed in claim 1, wherein the master display device further comprises a display proxy and a UI proxy.

8. The system as claimed in claim 1, wherein the slave display device further comprises a virtual frame buffer, a layout coordinator, a UI coordinator, and a network dispatcher.

9. The system as claimed in claim 1, wherein when the master display device transfers control to a slave display device, the slave display device acts as a master display device and the master display device acts as a slave display device.
